(19) United States
(12) Patent Application Publication
(10) Pub. No.: US 2020/0113193 A1
(43) Pub. Date: Apr. 16, 2020

(54) EDIBLE AND BIODEGRADABLE UTENSILS

(71) Applicant: Zhicong Kong, Oceanside, CA (US)

(72) Inventor: Zhicong Kong, Oceanside, CA (US)

(21) Appl. No.: 16/489,264

(22) PCT Filed: Feb. 27, 2018
(86) PCT No.: PCT/US2018/019918

§ 371 Date: Aug. 27, 2019

Related U.S. Application Data
(60) Provisional application No. 62/464,000, filed on Feb. 27, 2017.

(51) Int. Cl. A21D 13/48; A23P 30/10; A47G 21/02; A47G 21/04

(52) U.S. Cl. CPC A21D 13/48; A47G 21/04; A47G 21/023; A23P 30/10

(57) ABSTRACT

The present disclosure describes edible and biodegradable compositions that can be made into utensils. Methods of making the utensils are also provided.

### CROSS REFERENCE TO RELATED APPLICATION

This application claims the benefit of U.S. Provisional Application No. 62/464,000, filed Feb. 27, 2017, EDIBLE AND BIODEGRADABLE UTENSILS, which is herein incorporated by reference in its entirety for all purposes.

### INTRODUCTION

In the United States over 40 billion plastic utensils are used each year. Worldwide the number of plastic utensils used per year is estimated to be over 500 billion. The majority of these utensils are used once and then discarded and disposed of in a landfill. Millions of fast food restaurants and grocery stores contribute to this growing problem. Plastic utensils are used because of how inexpensive they are to produce. Technically, the plastic types that make up most plastic utensils, polypropylene and polystyrene, are recyclable, but most recycling plants do not accept them because they are cumbersome to process and not cost effective per unit. Because of that, most plastic utensils end up in a landfill. However, it is estimated that it will take a plastic spoon hundreds if not thousands of years to degrade, if at all. Disposable utensils filling up our landfills are a huge problem that cannot be ignored. Alternative, ecofriendly, and cost-efficient solutions must be developed.

### BACKGROUND

Designing a compostable utensil, for example, made of corn is one possible way to decrease our reliance on plastics. Compostable materials need specific conditions (for example, temperature, oxygen levels, UV light, water, anaerobic bacteria, etc.) to properly degrade. However, the majority of compostable utensils are thrown into a landfill where they are not able to degrade, thus negating their benefits.

Thus, there is a tremendous need to make utensils that can degrade outside of a landfill. In addition, if a degradable utensil is also edible, or can be used as a nutritional supplement, this will further reduce the number of utensils that end up in our landfills.

In addition to designing a compostable and edible utensil, the utensil must be practical so that various types of food can be eaten with the utensil. The utensil must be durable, flexible, able to withstand hot liquids without falling apart or degrading, and be comfortable for the user.

### SUMMARY

Provided herein are compositions that can be used to make edible and biodegradable utensils that comprise: about 55% to about 75% polysaccharides, about 14% to about 30% protein, about 4% to about 10% lipid, and about 5% to about 10% water. Exemplary compositions and methods of making the compositions are described below. The disclosed compositions can also be used: in agriculture as a food source, as a fertilizer, as a nutritional supplement (or nutrient source), or to make animal treats.

Provided herein are over 58 compositions that can be used to make edible and biodegradable utensils. Six exemplary compositions are provided below.

Composition 54

12 wt % to 27 wt % corn flour; and

6 wt % to 17 wt % rice flour; and

6 wt % to 13 wt % soy flour; and

18 wt % to 33 wt % high gluten flour; and

30 wt % to 40 wt % liquid.

Composition 55

18 wt % to 27 wt % corn flour; and

18 wt % to 27 wt % rice flour; and

9 wt % to 17 wt % soy flour; and

3 wt % to 6 wt % tapioca flour; and

3 wt % to 5 wt % potato flour; and

30 wt % to 40 wt % liquid.

Composition 56

12 wt % to 27 wt % corn flour; and

6 wt % to 17 wt % rice/oat flour; and

6 wt % to 13 wt % soy/peanut/flaxseed flour; and

18 wt % to 33 wt % high gluten flour; and

30 wt % to 40 wt % liquid.

Composition 57

12 wt % to 27 wt % corn flour; and

6 wt % to 10 wt % rice/oat flour; and

3 wt % to 6 wt % barley flour; and

18 wt % to 33 wt % high gluten flour;

6 wt % to 13 wt % soy/peanut/flaxseed flour; and

30 wt % to 40 wt % liquid.

Composition 58

12 wt % to 27 wt % corn flour; and

6 wt % to 10 wt % rice flour; and

6 wt % to 10 wt % oat flour; and

18 wt % to 33 wt % high gluten flour;

6 wt % to 13 wt % soy/peanut/flaxseed flour; and

30 wt % to 40 wt % liquid.

Composition 58

8 wt % to 18 wt % rice flour; and

5 wt % to 10 wt % barley flour; and

30 wt % to 40 wt % high gluten flour;

8 wt % to 18 wt % soy/peanut/flaxseed flour; and

30 wt % to 40 wt % liquid.

In some embodiments the liquid is milk, soy milk, or water. In some embodiments, the utensil is a spoon, fork, spork, knife, chop stick or stirrer. In some embodiments the utensil is biodegradable, the utensil is biodegradable inside or outside of a landfill, or the utensil is biodegradable at 10 degrees C. to 40 degrees C. In one embodiment, the utensil has a hydrophobic surface. In some embodiments, the compression force of the spoon is 250 to 500 Newton, the compression force of the spoon is 272 to 404 Newton, the compression force of the spork is 250 to 500 Newton, the compression force of the spork is 255 to 388 Newton, the compression force of the fork is 200 to 500 Newton, or the compression force of the fork is 230 to 351 Newton. In some embodiments, the utensil (e.g. fork, spoon, or spork) has a thickness of 1 to 5 mm or a thickness of 2 to 4 mm. In some embodiments, the utensil (e.g. fork, spoon, or spork) has an outer bend width of 13 mm to 15 mm, an inner bend width of 9 mm to 11 mm, a bend height of 5.5 mm to 10.5 mm. In some embodiments, the utensil (e.g. fork, spoon, or spork) has an outer bend width of 14 mm, an inner bend width of 10 mm, and a bend height of 6.5 mm to 9.5 mm. In one embodiment, the utensil is edible by a mammal (e.g. a human or non-human mammal). In some embodiments, the utensil has a handle length of 9.0cm to 9.5 cm or a handle length of less than 10 cm.

### BRIEF DESCRIPTION OF THE DRAWINGS

These and other features, aspects, and advantages of the present disclosure will become better understood with regard to the following description, appended claims and accompanying figures.

FIG. 1A to FIG. 1E shows the dimensions of exemplary utensils. FIG. 1A shows a side view of a spoon or fork. FIG. 1B shows a top view of a spoon and a fork. FIG. 1C shows a side view of a fork or spoon. FIG. 1D shows a top view of a fork. FIG. 1E shows a knife. All exemplary dimensions are shown in centimeters.

FIG. 2 shows an exemplary pair of chopsticks that can be made with the compositions disclosed herein.

FIG. 3 shows an exemplary pair of stirrers that can be made with the compositions disclosed herein.

FIG. 4 shows an exemplary fork that can be made with the compositions disclosed herein.

FIG. 5 shows a side view and a top view of an exemplary fork.

FIG. 6 shows an exemplary pressing mold (presser) used to make an individual utensil.

FIG. 7 shows the dimensions of an exemplary utensil. Examples of the “bend” of the utensil are shown by the two “U-shaped” curves on the top portion of the FIG. 7.

FIG. 8 shows an exemplary fork and a range of compression forces. The location of the testing is shown by a circle.

FIG. 9 shows an exemplary spoon and a range of compression forces. The location of the testing is shown by a circle.

### DETAILED DESCRIPTION

The following detailed description is provided to aid those skilled in the art in practicing the present disclosure. Even so, this detailed description should not be construed to unduly limit the present disclosure as modifications and variations in the embodiments discussed herein can be made by those of ordinary skill in the art without departing from the spirit or scope of the present disclosure.

As used in this disclosure and the appended claims, the singular forms “a”, “an” and “the” include a plural reference unless the context clearly dictates otherwise. As used in this disclosure and the appended claims, the term “or” can be singular or inclusive. For example, A or B, can be A and B.

ABOUT

The term “about” generally refers to plus or minus 10% of the indicated number. For example, “about 10%” may indicate a range of 9% to 11%, and “about I” may mean from 0.9-1.1

Utensils

A utensil can be, for example, a container, a plate, a dish, a bowl, a spoon, a fork, a knife, a spork, a chopstick, a stirrer, or a stick. A utensil can be a kitchen utensil or an eating utensil or any tool used in food preparation or consuming. A utensil can be any type of tableware.

Dimensions

The disclosed spoon, fork, or spork, will have the following dimensions.

A length of about 16 cm +/−2 cms.

A thickness of about 3 mm +/−1 mm. Alternatively, a thickness of about 2.0 mm to 4.0 mm.

A width at the widest part of about 3+/−2 cm.

Bend

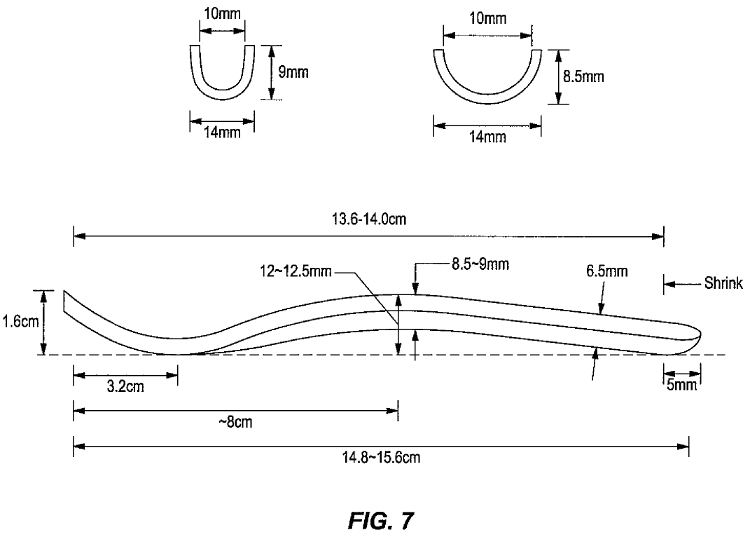

The bend of the utensil is shown in the top portion of FIG. 7. The edible utensils (fork, spoon, or spork) can have, for example, an outer bend width of 13 mm to 15 mm, an inner bend width of 9 mm to 11 mm, a bend height of 5.5 mm to 10.5 mm; or an outer bend width of 14 mm, an inner bend width of 10 mm, and a bend height of 6.5 mm to 9.5 mm.

Curve

The disclosed spoon, fork, or spork, will have a “curve” as shown in the lower portion of FIG. 7. This curve will have an angle of about 15 degrees to about 25 degrees, or about 19 degrees to about 20 degrees. Alternatively, the curve can be about 20 degrees+/−5 degrees.

The curve in section from highest to lowest point is about 9 mm, and never lower than 6 mm in the handle; the area that is 8 mm high is about 2.5˜3 cm long. When you lay down the fork in elevation (the lower portion of FIG. 7), the highest point in the prong is 1.6 cm high; the highest point in the handle is 1.2 cm which is about 8˜8.5 cm away from the point of the prong, as shown in FIG. 7.

Handle

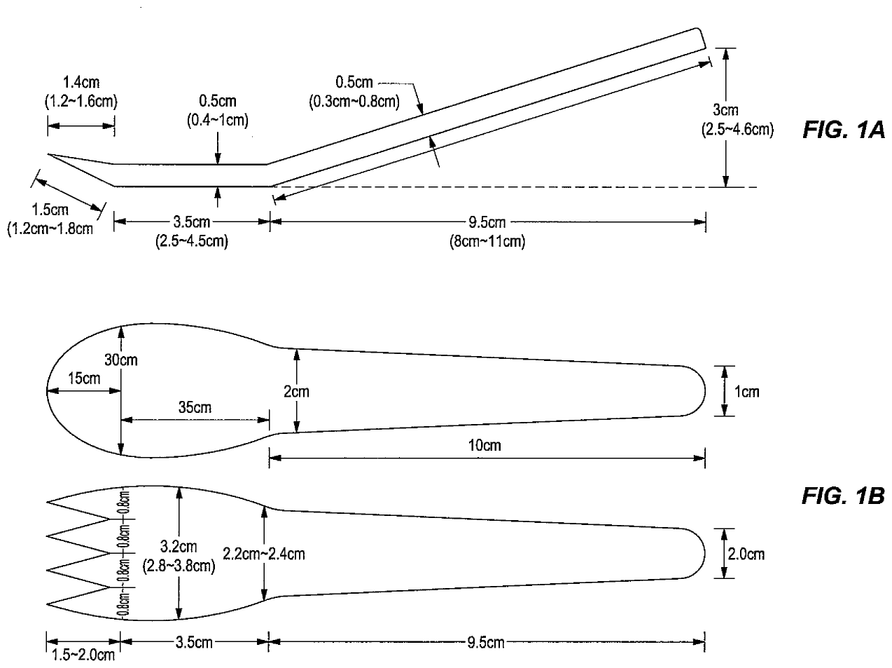

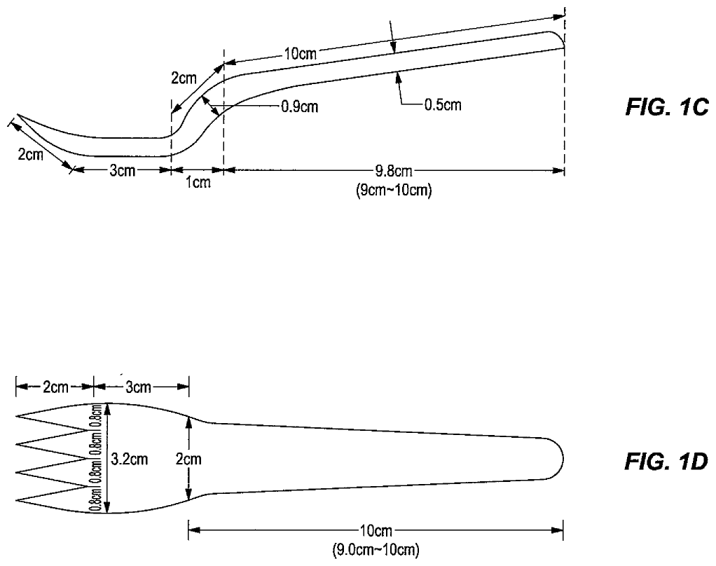

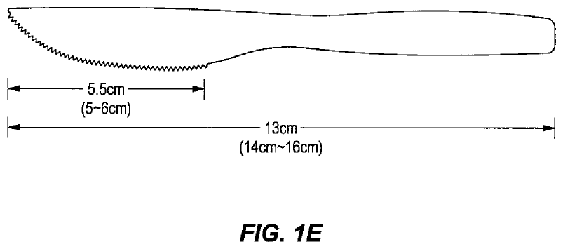

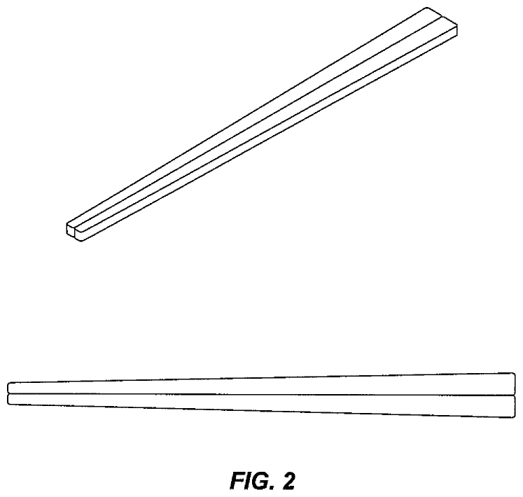

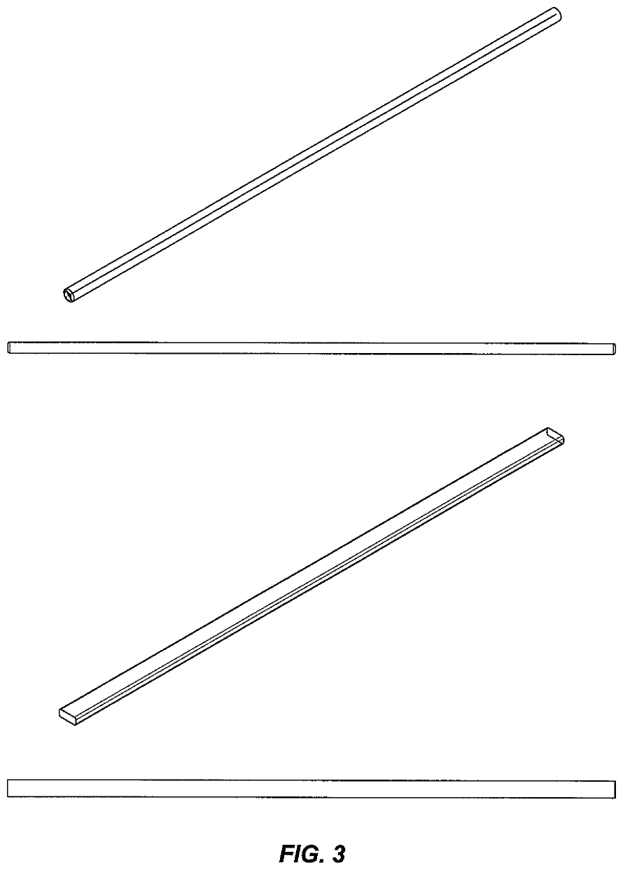

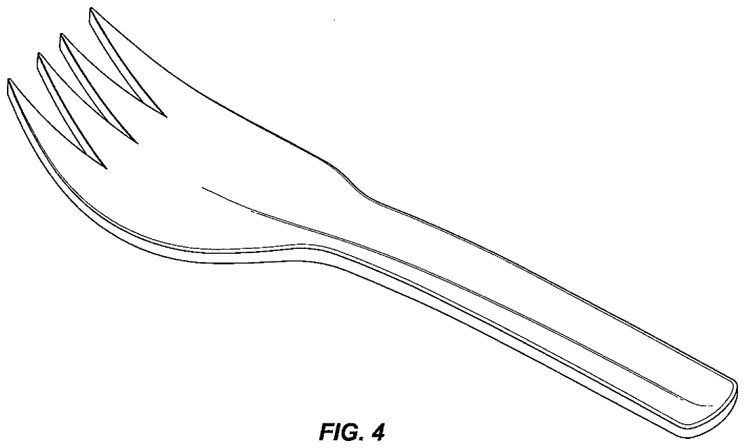

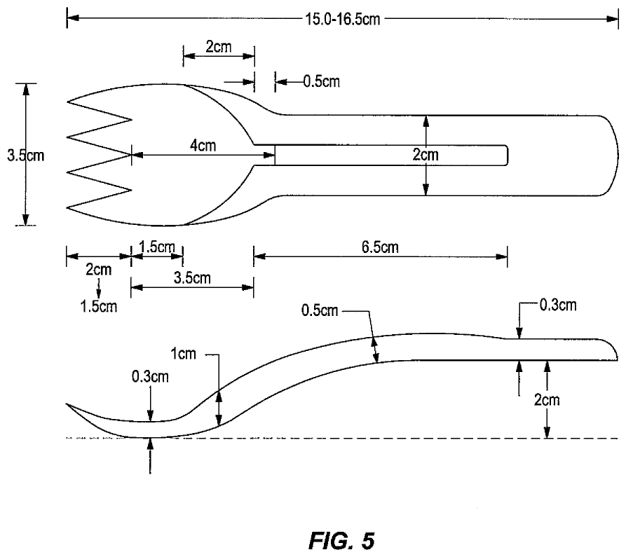

Strength of the handle is due to proper length of handle and proper curve and bend in the cross section. Fork handle length, as shown in FIG. 1B, is typically 9 to 10 cm long.

Prongs

The prongs of the fork can be thicker by 0.5 mm to 0.8 mm than other parts of the fork, and may contain a higher amount of oil; extra oil is added when cutting the dough.

Hydrophobicity of Utensils

The thin and reflective oil film covers the surface of product so that it becomes hydrophobic and long lasting. The combination of the disulfide bonds within gluten, the hydrophobic surface and a film residue of oil inside the product is what makes the utensil resistant to hot water and other liquids. Therefore, most of the formulas require wheat flour with high gluten; the percentage of protein in the formula should be no less than 14%; 10˜20% of oil crops in the formula is necessary. To control the amount of water in dough and reduce the dehydration period, corn or other flour that does not absorb too much water is added in most cases.

Exemplary Ingredients

The below listed ingredients can be used to make the disclosed utensils. Exemplary flours and their ingredients and nutritional facts are provided below.

Two Whole Wheat Flours are shown below.

Semolina Flour/Durum Flour

Whole Grain Corn Flour

Soy Bean Flour

Vital Wheat Gluten Flour

White Rice Flour

Barley Flour

Tapioca Flour

Whole Grain Oats Flour

Gluten-Free Whole Grain Oats Flour

Garbanzo Bean Flour

Sorghum Flour

Whole Grain Dark Rye Flour

Three Gluten-Free All-Purpose Baking Flours

Gluten-free Whole Grain Corn Flour. For gluten-free formulas corn flour can also be used.

Whole Grain Triticale Flour

Rapeseed Oil

Palm Oil

Edible Gum

Edible gum

| | |
|---|---|
| vegetable gum | Agar, Jelly-T |
| (Vegetarian) | Carrageenan |
| | Locust bean gum |
| | Guar gun |
| | Acacia gum |
| | Karaya gum |
| | Tara gum |
| | Konjac gum |
| | Pectin |
| Microbial gum | Xanthan gum |
| (Vegetarian) | Gellan gum |
| | Curdian gum |
| Animal glue | Gelatine |
| | Shellac |

Guar Gum

Xanthan Gum

Agar Powder

Honeysoy Soy Flour (CHS)

Cowpea Bean Flour

| | |
|---|---|
| Protein | 24.8% |
| Fat | 1.9% |
| Fiber | 6.3% |
| Carbohydrate | 63.6% |
| Thiamine | 0.00074% |
| Riboflavin | 0.00042% |
| Niacin | 0.00281% |

Oil Palm Kernel Cake: the Remainder of the Oil Palm Kernel After Extracting the Oil.

| Component | Palm kernel cake |
|---|---|
| Dry matter (%) | 92.25 |
| Crude protein (% DM) | 14.34 |
| Ether extract (%DM) | 10.56 |
| Neutral detergent fiber or ¹ (% DM) | 65.63 |
| Acid detergent fiber (% DM) | 46.12 |
| Lignin (% DM) | 18.31 |
| Mineral matter (% DM) | 3.13 |

Potato Flour

Coconut Flour

Peanut Flour

Lupine Bean Flour

Flax Seed Flour

Sunflower Seed Flour

High Gluten Flour (Honeyville)

High Gluten Flour (Webstaurant)

Winged Bean Flour

High-Gluten Wheat Flour (30%). The columns entitled “High Grade” and “First Grade” are examples of high-gluten wheat flour (30%).

| | | | | Whole |
|---|---|---|---|---|
| | | | | grain |
| Quality | High | First | Second | wheat flour |
| Characteristics | Grade | grade | grade | “Zhitnitsa” |
| Color | White or | White or | White or | White or |
| | white with | white with | white with | white with |
| | a cream hue | a yellowy | a yellowy | a yellowy |
| | | hue | or greyish | hue |
| | | | hue | |
| Ash Content | Max. 0.55% | Max. 0.75% | Max. 1.25% | Max 1.9% |
| Whiteness | Min. 54% | Min. 36% | Min. 12% | Max. 11% |
| Raw gluten | Min. 28% | Min. 30% | Min. 25% | Min. 20% |
| Protein | Min. 11% | Min. 12.5% | Min. 13% | Min. 15% |
| Moisture | Max. 14% | Max. 14% | Max. 14% | Max. 13% |
| content | | | | |
| Packaging | 1, 2, 3, 5, | | 15, 50 kg | |
| | 10, 25, 50 kg | | | |

A Liquid

A liquid can be milk (about 88% water). Milk can be whole milk, 1% whole milk, 2% whole milk, almond milk, or soy milk. A liquid can be water. A liquid can be a mixture of water and milk.

Properties of Ingredients Used in the Disclosed Compositions

Whole wheat flour comprises straight chain and branched polysaccharides, as well as about 4 g to 5 g gluten protein per 38 g flour. The main polysaccharides are branched. Whole wheat flour absorbs water during the kneading of the dough (composition).

The gluten protein in vital wheat gluten flour increases protein-protein interactions and protein-polysaccharide interactions. In other words, the gluten protein serves as “glue.” Gluten increases the strength of the material by forming disulfide bonds between proteins, forming an amide bond between a protein and a polysaccharide, and forming a hydrogen/ionic bond amongst proteins and polysaccharides. Gluten increases the density, stickiness, and elasticity of the composition.

Corn flour provides zein protein which does not dissolve in water. Corn flour does not absorb much water during kneading of the dough or during use of the utensil. Corn flour makes the material (composition) more hydrophobic. Corn flour has a higher percentage of straight chain polysaccharides than branched polysaccharides. Thus, the gap between the branched polysaccharides can be filled with straight chain polysaccharides from wheat flour and corn flour. Corn flour can be replaced by sorghum flour in the disclosed compositions.

In the following, Soybean refers to soy flour, see for example, Honeysoy soy flour described above.

Soy flour, along with other beans and oil crops, comprises crude proteins, lipids, and minerals. The proteins help fill the gaps between polysaccharides, as well as increase the strength of the final product. The lipids make the material more hydrophobic. The presence of lipids in the material prevents sticking of the material to a mold during stamping. The presence of lipids in the material also prevents sticking of the material to a roller during flattening. Minerals promote the redox of disulfide, amide, and ionic bond formation due to the presence of ions, such as Calcium, Magnesium, etc.

Barley flour and whole grain oat flour have beta glucan, which comprise different ratios of trimer and tetramer 1-4 linkages. Beta glucan, also called gum, is used to glue together the network of polysaccharides present in wheat, barley, lipids, proteins, and minerals from various beans (for example, soybeans), and within the beta glucan molecule itself.

Rice flour has amylose which can bind to amylopectin and form a stronger, more insoluble, and higher density chemical structure within the composition.

Gum can replace gluten in the disclosed compositions. About 0.1% to about 5% dry weight of an edible gum additive can be added as an ingredient to increase the strength of the product. Gum comprises mainly beta polysaccharides which increase the texture of the composition. Gum can be added to gluten-free and low gluten formulas (compositions), or replace vital wheat gluten flour in high gluten flour formulas (compositions). Exemplars of gums are guar gum, xanthan gum, and oat gum. Oat gum also comprises mainly beta polysaccharides. The beta polysaccharides have the same mechanism as pectin and form cross links in the composition with casein, upon the addition of either borax or calcium to the composition. When the composition is placed in hot water above 80 degrees Celsius, the final viscosity is only slightly reduced. The presence of beta polysaccharides in a composition also prevents shrinking during dehydration. Other exemplary gums that can be added to the disclosed compositions are shown above, mainly, agar agar jelly T, carrageenan, locust bean gum, acacia gum, karaya gum, tara gum, konjac gum, pectin, gellan gum, curdlan gum, gelatin, and shellac. If guar gum is added to a composition, calcium must also be added. If xanthan gum is added to a composition, calcium can be added but does not have to be added.

Several of the disclosed compositions use soybeans, garbanzo beans, or cowpea beans. Alternative beans that can be used in the compositions are: beans (Phaseolus and Vigna spp.); bambara beans (Voandzeia subterranean); peas (Pisum sativum); chick peas (Cicer arietinum); broad beans (Vicia faba); string beans (Phaseolus vulgaris); soybeans (Glycine soja); cow peas (Vigna sinensis; Dolichos sinensis); pigeon peas (Cajanus cajan); lentils (Lens esculenta; Ervum lens); carobs (Ceralonia silique); vetches (Vicia sativa); or lupins (Lupines spp.); winged bean (Psophocarpus tetragonolobus).

The liquid of the compositions, for example, water, can be at a temperature of about 25 to about 40 degrees Celsius. Alternatively, water can be at a temperature less than about 30 degrees Celsius. The pH of the water should be from about 8 to about 9. The temperature and basic environment of the water promotes disulfide bond formation within the disclosed compositions.

Polysaccarides, Proteins, Lipids, and Liquids Present in the Compositions

An exemplary composition that can be used to make the disclosed utensils can comprise: about 55% to about 75% polysaccharides (for example, over 30% amylose in total polysaccharides), about 14% to about 30% protein, about 4% to about 10% lipid, and about 5% to about 10% water.

Exemplary sources of protein are: gluten, protein from beans, casein, whey, calcium caseinate, sodium caseinate, and beta casein.

Exemplary sources of lipids are: bean oil, milk fat, corn oil, oat fat, and triglycerides.

Exemplary polysaccharides are: amylose, amylopectin, pectin, a high methoxyl pectin, a low methoxyl pectin, a negatively charged polysaccharide, xanthan gum and other kinds of gum.

Amylose (about 20-30% in cereals) can be from beans, rice, corn, wheat, oat, barley, or sorghum. For example, beans have about 30% to about 40% amylose and sorghum has about 18% amylose. Amylose increases the density, strength, and hydrophobicity of the composition. Amylopectin can make up about 70% to about 80% of the polysaccharides found in cereals. Beta-glucan is one kind of amylopectin; it exists in barley and oat and is known as “gum.” Therefore, the presence of barley and oat in a composition as disclosed herein can also increase the interactions between lipids, proteins and polysaccharides. However, a higher percentage of these two flours can increase the viscosity of the composition (material).

Gluten and Gluten-Free

Gluten is a protein that occurs naturally in wheat, rye, barley, and crossbreeds of these grains. Foods that typically contain gluten include breads, cakes, cereals, pastas, and many other foods.

The US Food and Drug Administration (FDA) established, among other criteria, a gluten limit of less than 20 parts per million (ppm) for foods that carry the label “gluten-free,” “no gluten,” “free of gluten,” or “without gluten.”

In addition to limiting the unavoidable presence of gluten to less than 20 ppm, the FDA now allows manufacturers to label a food “gluten-free” if the food does not contain any of the following: an ingredient that is any type of wheat, rye, barley, or crossbreeds of these grains; an ingredient derived from these grains and that has not been processed to remove gluten; and an ingredient derived from these grains and that has been processed to remove gluten, if it results in the food containing 20 or more parts per million (ppm) gluten.

For the compositions disclosed herein, the meaning of gluten-free follows the requirements set forth by the FDA. Low-gluten and high-gluten compositions comprise greater than about 20 ppm gluten. In addition, for low-gluten compositions, the percent protein in dry weight, prior to adding a liquid (for example, water) is less than about 20% protein. For high-gluten compositions, the percent protein in dry weight, prior to adding a liquid (for example, water) is greater than about 20% protein.

Use of Soy Milk in the Disclosed Compositions

If soymilk is used (which is made of up about 60 g to about 100 g dry weight of soybean per 1000 mL water) instead of water or milk, “soy flour” as an ingredient is substituted with another flour in the composition. For example, if soymilk is used to make the “Southern East Asian” described below in Example 16, No. 5, soy flour would not be used, but instead another flour in the list would be substituted, resulting in twice as much of the chosen flour in the composition. Many beans that contain a high percentage (over about 20 g protein per 100 grams of raw material) of protein can replace soybean or garbanzo beans, such as cocoa bean, mung bean, adzuki bean, black turtle bean, etc., or a combination thereof.

The presence of protein in the compositions increases the strength of the composition and the product (utensil), explaining why high-gluten formulas normally have the best mechanical properties. Also, the lipid, provided mainly from the bean can increase the hydrophobicity of the product so that the product keeps its morphology and mechanical properties in hot water.

Advantages of the Disclosed Utensils

The disclosed utensils are both edible and biodegradable. The disclosed utensils are able to biodegrade outside or inside a landfill. The utensils can be degraded at normal temperatures, for example, about 10 degrees Celsius to about 40 degrees Celsius, with the help of fungus and bacterium. In addition, moisture can help promote biodegradation. The disclosed utensils are eco-friendly compared to petroleum-based (for example, polypropylene (PP) and polystyrene (PS)) and bio-based (for example, based on corn (polylactic acid (PLA) or polylactide aliphatic copolymer (CPLA), or starch) plastic products. Unlike many petroleum-based plastic utensils, degradation of the disclosed utensils does not cause the release of methane which is much more harmful than carbon dioxide in contributing to greenhouse gases (GHG). The disclosed utensils degrade at a comparable or faster rate than starch-based plastic utensils. Pure PLA cannot degrade in water (for example, in the ocean) or at room temperature as a solid. Some high-temperature-tolerant bio-based plastics mix PLA and PP, further reducing their ability to degrade.

In developed countries, most biodegradable utensils are constructed of PLA or CPLA. These types of products require a dedicated recycling system to degrade. Also, these types of products cannot degrade effectively even in warm temperatures (lower than 50 degrees C.). In contrast, the disclosed utensils can degrade in warm temperatures (10˜50 degrees C.) with moderate moisture. 1001431 The disclosed utensils have a shape of a fork, with prongs of adequate strength to grab food even when the food is hot or wet. Also, the disclosed utensils are thin but strong, with a bent handle. These advantages are a result of the composition (ingredients) of the utensils and the gentle manufacturing process that is used to make the utensils.

The strength of the disclosed utensils is a direct result of the complex mix of proteins, polysaccharides and lipids that are in each of the disclosed compositions. Strong bonds, for example, a disulfide bond formed within gluten, result in a durable utensil. A thin and reflective oil film covers the surface of product so that it becomes hydrophobic and long lasting. The combination of the disulfide bonds within gluten, the hydrophobic surface, and a film residue of oil inside the product is what makes the utensil resistant to hot water and other liquids. Therefore, several of the formulas require wheat flour with high gluten; the percentage of protein in the formulas should be no less than 14%; 10˜20% of oil crops (crops from which oil can be extracted for food or industrial use) in the formula is necessary. To control the amount of water in dough and reduce the required dehydration period, corn or other flour that doesn't absorb too much water is added in some cases.

The strength of the handle is a result of a certain length of the handle (9-9.5 cm and no longer than 10 cm) and a certain curve in the cross section, as shown in FIG. 7. Building in a larger gap between vertically stacked molds allows the fork prong to be thicker by 0.5 mm˜0.8 mm than other parts of the fork, along with a higher amount of oil; extra oil is added when cutting the dough.

The cost of making the disclosed utensils would be comparable or less than petroleum-based plastic products. Compared to starch-based plastic utensils, the disclosed utensils are less expensive to make.

A utensil can be a mix of petroleum-based and bio-based compounds. This type of mix is an “impure” bio-based product. A “pure” bio-based product does not include petroleum-based products.

The disclosed utensils are made of a material (a composition) that is a mixture of specific ingredients. An exemplary material used to make the disclosed utensils is a “sheet” of the pressed composition. Leftover material, for example, the sheet after the shape of a spoon has been “stamped” can be used as a food (nutrient) source. Another nutrient source is the utensil itself, either new or used.

The materials (compositions) can be used in agriculture as a food source (for example, as fodder for livestock), as a fertilizer, or as a nutritional supplement, due to the presence of polysaccharides, proteins, nitrogen, phosphorus, vitamins, and minerals (for example, ions of calcium, magnesium, sodium, potassium, etc.).

For example, the material can be used as a nutritional source for insect larvae such as mealworms (Tenebrio molitor) or “superworms” (Zophobas morio). The material can be used to breed insect larvae, in combination with an external fruit or vegetable source that provides water and vitamins.

The material can also be used as nourishment for fungus. In some formulations, milk would be added, such that the material contains most of the necessary nutritional elements, such as carbohydrates, fat, protein, minerals, vitamins, with the exception of Vitamin C.

In addition, the material (compositions) can also be used to make animal treats, for example, dog treats. Also, the material can be used to make biodegradable food storage containers. After the food is eaten, the container can be put in the trash and biodegraded.

Compositions

Several exemplary compositions are described below. Also, provided below, are several terms that are defined and relate to the disclosed compositions.

Each of the following exemplary compositions, the total weight of dry material is 100 g prior to adding water, milk, or a liquid. All percentages listed below are weight percent. Multiplying mass fraction by 100 gives the mass percentage. It is sometimes called weight percent (wt %) or weight-weight percentage. All percentages disclosed herein are wt %.

When a “/−” is present in the disclosure, it means the alternative. For example, “Water/milk” means “water” or “milk.”

Gluten free: no whole-wheat flour, high-gluten flour, or vital-wheat-gluten flour is used. Gluten-free all-purpose flour may be used in the composition.

Low Gluten: Whole Wheat Flour.

High Gluten: high gluten flour or a combination of whole wheat flour and vital wheat gluten flour.

Each of the disclosed compositions (for example, Composition 1) can be claimed using, for example, the language of claim 1 presented below. For example, each edible utensil comprises certain ingredients (for example, whole wheat flour, vital wheat gluten flour, whole grain corn flour, and soy flour) at certain ranges of weight percentages (wt %), and then the remaining weight percentage is a liquid, such as water, milk, or soy milk. In other words, each ingredient can be adjusted to a certain weight percentage within a disclosed range, and then the amount of liquid is adjusted up to 100%.

Composition 1 (High-Gluten China and United States

Ingredient 1: Whole wheat flour 18% to 33%

Ingredient 2: Vital wheat gluten flour (80% protein) 3% to 17%

Ingredient 3: Whole grain corn flour 12% to 27%

Ingredient 4: Soy flour 6% to 20%

Ingredient 5: Water 30% to 40% or

Ingredient 6 (Alternative for water): Milk 30% to 40% 1001681 Same temperature requirement for milk as for water. Milk pH should be about 6 to about 7. Water should be 7-8 pH.

Composition 2 (High-Gluten China and American)

Ingredient 1: High gluten flour 12% to 27%

Ingredient 2: Whole grain corn flour, barley flour or sorghum flour 12% to 20%

Ingredient 3: Rice flour 9%-17% (provides polysaccharides and proteins)

Rice has amylose, which can hold amylopectin and from a strong, insoluble and high density network.

Ingredient 4: Vital wheat gluten flour 3% to 13%

Ingredient 5: Soy flour 6% to 20%

Ingredient 6: Water 30% to 40%

Composition 3 (Gluten-Free/Low Gluten Amerca, Africa, and China)

Ingredient 1: Gluten-free all-purpose baking flour/whole wheat flour 18% to 27%

Ingredient 2: Whole grain corn flour or sorghum flour 12% to 20%

Igredient 3: Rice flour 12% to 20% (provides polysaccharides and proteins)

Ingredient 4: Soy flour 6% to 20%

Ingredient 5: Water 30% to 40%

Composition 4 (High-Glutrn Cada/EUROPE FORMULA)

Ingredient 1: Whole wheat flour, or half whole grain dark rye flour and half whole wheat flour, or whole grain triticale flour 18% to 33%

Ingredient 2: Barley flour 12% to 27% (provides minerals, polysaccharides, proteins) or whole grain corn flour or sorghum flour 12% to 27%

Ingredient 3: Whole grain oats flour 6% to 20%

Ingredient 4: Vital wheat gluten flour 3% to 13%

Ingredient 5: Soy flour 6% to 13%

Ingredient 6: Water 30% to 40%

Composition 5 (Gluten-Free/Low Gluten Canda-Europe Formula)

Ingredient 1: Gluten-free all-purpose baking flour/whole wheat flour 18% to 33%

Ingredient 2: Whole grain corn flour 12% to 27%, sorghum flour or barley flour (provides minerals, polysaccharides (beta-glucan), proteins, and insoluble composition)

Ingredient 3: (Gluten-free) whole grain oats flour 6% to 20% (provides oat beta-glucan, which is polysaccharide gum)

Ingredient 4: Soy flour 6% to 20% 1001951 Ingredient 5: Water 30% to 40%

Composition 6 (Gluten-Free/Low Gluten Glutent

AUSTRALIA

Ingredient 1: Gluten-free all-purpose baking flour/whole wheat flour 18% to 33%

Ingredient 2: Whole grain corn flour or sorghum flour 12% to 27% (provides minerals, polysaccharides, proteins)

Ingredient 3: (Gluten-free) whole grain oats flour 6% to 20%

Ingredient 4: Garbanzo bean flour 6% to 20% (provides lipids, polysaccharides, protein, minerals)

Ingredient 5: Water 30% to 40%

Composition 7 (High-Gluten Australia Formula)

Ingredient 1: Whole wheat flour 18% to 33%

Ingredient 2: Barley flour 12% to 27% (provides lipids, minerals, polysaccharides, proteins) or whole grain corn flour or sorghum flour

Ingredient 3: Whole grain oats flour 6% to 20%

Ingredient 4: Vital wheat gluten flour 3% to 13%

Ingredient 5: Garbanzo bean flour 6% to 20%

water 30% to 40%

Composition 8 (Gluten-Free Africa, Middle America and Southern East Asia)

Ingredient 1: Rice flour 12% to 27%

Ingredient 2: Whole grain corn flour 12% to 20% or sorghum flour 12% to 20%

Ingredient 3: Tapioca flour 0% to 12%

Ingredient 4: Soy flour 6% to 20%

Ingredient 5: Water 30% to 40%

Composition 9 (Gluten/Low Gluten-Free/Low Gluten America or Australia

Ingredient 1: Gluten-free all-purpose baking flour/whole wheat flour 18% to 27%

Ingredient 2: (Gluten-free) whole grain oats flour 12% to 20%

Ingredient 3: Rice flour 12% to 20%

Ingredient 4: Soy flour or Garbanzo bean flour 6% to 20%

Ingredient 5: Water 30% to 40%

Composition 10 (Gluten-Free/Low Gluten America or Australia with Water)

Ingredient 1: Gluten-free all-purpose baking flour/whole wheat flour 18% to 27%

Ingredient 2: Whole grain corn flour or sorghum flour 12% to 20%

Ingredient 3: (Gluten-free) whole grain oats flour 6% to 20%

Ingredient 4: Rice flour 6% to 20%

Ingredient 5: Soy flour or Garbanzo bean flour 6% to 20%

Ingredient 6: Water 30% to 40%

Composition 11 (Gluten-Free/Low Gluten Formula with Milk)

Note: Use casein from milk to replace gluten

Ingredient 1: Gluten-free all-purpose baking flour/whole wheat flour 18% to 33%

Ingredient 2: Whole grain corn flour or sorghum flour 12% to 27%

Ingredient 3: Soy flour 6% to 20%

Ingredient 4: Whole milk 30% to 40% (provides lipids, proteins, minerals, vitamins)

Composition 12

Ingredient 1: Whole wheat flour 24% to 33%

Ingredient 2: Whole grain corn flour or sorghum flour 18% to 27%

Ingredient 3: Vital wheat gluten flour (80% protein) 3% to 13%

Ingredient 4: Soy milk 30% to 40%

Composition 13 (Gluten-Free/Low Gluten)

Ingredient 1: Gluten-free all-purpose baking flour/whole wheat flour 18% to 33%

Ingredient 2: Whole grain corn flour or sorghum flour 18% to 27%

Ingredient 3: Soy flour 6% to 20%

Ingredient 4: Water or whole milk 30% to 40%

Composition 14 (Gluten-Free/Low Gluten)

Ingredient 1: Gluten-free all-purpose baking flour/whole wheat flour 18% to 33%

Ingredient 2: Rice flour 12% to 27%

Ingredient 3: Soy flour 6% to 20%

Ingredient 4: Water 30% to 40%

Composition 15 (High-Gluten)

Ingredient 1: Durum flour 30% to 47%

Ingredient 2: Whole grain corn flour or sorghum flour 12% to 27%

Ingredient 3: Soy flour 6% to 20%

Ingredient 4: Water 30% to 40%

Compositions 16-21 (Gluten Free)

Six alternative gluten-free compositions are shown below

16. The Americas (except for Canada) and South Africa

Gluten-free all-purpose baking flour 20% to 33%

Sorghum flour/Gluten-free whole grain corn flour 12% to 27%

Rice flour/gluten-free whole grain oats flour 12% to 27%

Soy flour 12% to 27%

Water/milk 30% to 40%

17. China

Tapioca flour 6% to 13%

Sorghum flour 12% to 27%

Rice flour 18% to 33%

Soy flour 12% to 27%

Water/milk 18% to 27%

18. Europe and Canada

Gluten-free all-purpose baking flour 18% to 33%

Gluten-free whole grain corn flour 12% to 27%

Gluten-free whole grain oats flour 12% to 27%

Soy flour 12% to 27%

Water/milk 30% to 40%

19. Australia

Gluten-free all-purpose baking flour 18% to 33%

Sorghum flour 12% to 27%

Gluten-free oats/rice flour 12% to 27%

Roasted garbanzo flour 12% to 27% and optionally add ˜2% weight rapeseed oil

Water/milk 30% to 40%

20. Southern East Asia

Tapioca flour 0% to 27%

Gluten-free whole grain corn flour 12% to 27%

Rice flour 18% to 33%

Soy flour 12% to 27%

Water/milk 30% to 40%

21. Northern and Western Africa

Tapioca flour 6% to 12%

Rice flour 18% to 33%

Whole grain corn flour 12% to 27%

Roasted cowpea bean flour 12% to 27% and optionally add ˜2% weight palm oil

Water/milk 30% to 40%

Compositions 22-27 (Low Gluten)

Six alternative low-gluten compositions are shown below.

22. The Americas (Except for Canada) South Africa

Semolina flour 24% to 36%

Whole grain corn flour/sorghum flour 12% to 27%

Rice flour 12% to 27%

Soy flour 12% to 27%

Water/milk 18% to 27%

23. China

Whole wheat flour 24% to 40%

Whole grain corn flour/sorghum flour 12% to 27%

Rice flour 12% to 27%

Soy flour 12% to 27%

Water/milk 30% to 40%

24. Europe and Canada

Whole wheat flour/semolina flour/half whole wheat flour and half whole grain dark rye flour/whole grain triticale flour 21% to 37%

Barley flour 6% to 20%

Whole grain oats flour 12% to 27%

Soy flour 12% to 27%

Water/milk 30% to 40%

25. Australia

Whole wheat flour/semolina flour 24% to 40%

Sorghum flour 12% to 27%

Gluten-free whole grain oats flour/rice flour 12% to 27%

Roasted garbanzo flour 12% to 27% and optionally add ˜2% weight rapeseed oil

Water/milk 30% to 40%

26. Southern East Asia

Whole wheat flour 6% to 20%

Whole grain corn flour 12% to 27%

Rice flour 18% to 33%

Tapioca flour 0% to 13%

Soy flour 12% to 27%

Water/milk 30% to 40%

27. Northern and Western Africa

Whole Wheat flour 6% to 20%

Rice flour 18% to 33%

Whole grain corn flour 12% to 27%

Roasted cowpea bean flour 12% to 27% and optionally add ˜2% weight palm oil

Water/milk 30% to 40%

Compositions 28-33 (High Gluten)

Six alternative high-gluten compositions are shown below.

28. The Americas (Except for Canada) and South Africa

Whole wheat flour/semolina flour 24% to 40%

Whole grain corn flour/sorghum flour 12% to 27%

Vital wheat gluten flour 3% to 17%

Soy flour 12% to 27%

Water/milk 30% to 40%

29. China

Whole wheat flour/rice flour 27% to 40%

Whole grain corn flour/sorghum flour 12% to 27%

Vital wheat gluten flour 3% to 13%

Soy flour 12% to 27%

Water/milk 30% to 40%

30. Europe and Canada

Whole wheat flour/semolina flour/half whole wheat flour and half whole grain dark rye flour/whole grain triticale flour 40% to 60%

Barley flour 12% to 27%

Vital wheat gluten flour 3% to 17%

Soy flour 6% to 20%

Water/milk 30% to 40%

31. Australia

Whole wheat flour/semolina flour 24% to 40%

Sorghum flour 12% to 27%

Vital wheat gluten flour 3% to 17%

Roasted garbanzo bean flour 12% to 27% and optionally add ˜2% weight rapeseed oil

Water/milk 30% to 40%

32. Southern East Asia

Rice flour 12% to 27%

Whole grain corn flour 12% to 27%

Tapioca flour 0% to 12%

High-gluten wheat flour 6% to 20% or Vital wheat gluten flour 3% to 17%

Soy flour 6% to 20%

Water/milk 30% to 40%

33. Northern and Western Africa

High-gluten wheat flour/Durum flour 6% to 20% or Vital wheat gluten flour 3% to 17%

Rice flour 20% to 33%

Whole grain corn flour 12% to 27%

Roasted cowpea bean flour 6% to 20% and optionally add ˜2% weight palm oil

Water/milk 30% to 40%

Exemplary Gluten-Free Compositions

| | | |
|---|---|---|
| 2 Combinations | Gluten-free all-purpose | Tapioca/Gluten-free whole |
| of 3 types | baking flour 24%-47% | grain corn flour |
| of flour | | 6%-27% |
| | Rice flour/gluten-free | Rice flour/gluten-free |
| | whole grain oats flour | whole grain oats flour |
| | 12%-33% | 24%-47% |
| | Soy flour/roasted | Soy flour/roasted |
| | garbanzo | garbanzo bean flour |
| | bean flour 12%-27% | 12%-33% |
| Liquid | Water/milk 30% to 40% | Water/milk 30% to 40% |
| 2 Combinations | Gluten-free all-purpose | Tapioca flour |
| of 4 types | baking flour 18%-33% | 6%-27% |
| of flour | Sorghum flour/Gluten-free | Sorghum flour/Gluten-free |
| | whole grain corn flour | whole grain corn flour |
| | 12%-27% | 12%-27% |
| | Rice flour/gluten-free | Rice flour/gluten-free |
| | whole grain oats flour | whole grain oats flour |
| | 12%-27% | 18%-33% |
| | Soy flour/roasted garbanzo | Soy flour/roasted garbanzo |
| | bean/cowpea bean flour | bean/cowpea bean flour |
| | 12%-27% | 12%-27% |
| Liquid | Water/milk 30% to 40% | Water/milk 30% to 40% |
| 2 Combinations | Tapioca flour | Gluten-free all-purpose |
| of 5 types | 6%-13% | baking flour 18%-33% |
| of flour | Rice flour 18%-33% | Rice flour 12%-27% |
| | Sorghum flour/Gluten-free | Sorghum flour/Gluten-free |
| | whole grain corn flour | whole grain com flour |
| | 12%-27% | 12%-27% |
| | Soy flour/garbanzo | Soy flour/garbanzo |
| | bean/cowpea bean flour | bean/cowpea bean flour |
| | 12%-27% | 12%-27% |
| | Gluten-free whole grain | Gluten-free whole grain |
| | oats flour 6%-20% | oats flour 6%-20% |
| Liquid | Water/milk 30% to 40% | Water/milk 30% to 40% |
| 2 Combinations | Tapioca flour 6%-13% | Gluten-free |
| of 6 types | | whole grain oats |
| of flour | | flour 6%-20% |
| | Rice flour 18%-33% | Rice flour 12%-27% |
| | Sorghum flour 6%-20% | Sorghum flour 6%-20% |
| | Soy flour/garbanzo | Soy flour/garbanzo |
| | bean/cowpea bean flour | bean/cowpea bean |
| | 6%-20% | flour 6%-20% |
| | Gluten-free whole grain | Gluten-free whole grain |
| | oats flour 6%-20% | corn flour 6%-20% |
| | Gluten-free whole grain | Gluten-free |
| | corn flour 6%-20% | all-purpose |
| | | baking flour |
| | | 18%-33% |
| Liquid | Water/milk 30% to 40% | Water/milk 30% to 40% |

Exemplary Low-Gluten Compositions

| | |
|---|---|
| Combinations | Whole wheat flour/ |
| of 3 types | semolina flour/half whole |
| of flour | wheat flour and half whole |
| | grain dark rye flour/whole |
| | grain triticale flour 24%-47% |
| | Rice flour/whole grain oats |
| | flour/whole grain corn |
| | flour/sorghum flour/barley |
| | flour 12%-27% |
| | Soy flour/garbanzo bean |
| | flour 12%-27% |
| Liquid | Water/milk 30% to 40% |
| Combinations | Whole wheat |
| of 4 types | flour/semolina flour/half |
| of flour | whole wheat flour and half |
| | whole grain dark rye |
| | flour/whole grain triticale |
| | flour 24%-40% |
| | Barley flour/whole grain |
| | corn flour/sorghum |
| | flour 6%-27% |
| | Whole grain oats flour/rice |
| | flour 12%-27% |
| | Soy flour/garbanzo bean |
| | flour 12%-27% |
| Liquid | Water/milk 30% to 40% |
| Combinations | Whole wheat |
| of 5 types | flour/semolina flour/half |
| of flour | whole wheat and half |
| | whole grain dark rye |
| | flour/whole grain triticale |
| | flour 12%-33% |
| | Rice flour 12%-27% |
| | Sorghum flour/whole grain |
| | corn flour 12%-27% |
| | Soy flour/garbanzo bean |
| | flour 12%-27% |
| | Whole grain oats |
| | flour 6%-20% |
| Liquid | Water/milk 30% to 40% |
| Combinations | Whole wheat flour/ |
| of 6 types | semolina flour/half whole |
| of flour | wheat and half whole grain |
| | dark rye flour/whole grain |
| | triticale flour 12%-27% |
| | Rice flour 12%-27% |
| | Sorghum flour 6%-20% |
| | Whole grain corn |
| | flour 6%-20% |
| | Oats flour 6%-20% |
| | Soy flour/garbanzo bean |
| | flour 6%-20% |
| Liquid | Water/milk 30% to 40% |

Alternative High-Gluten Compositions

| | | |
|---|---|---|
| 2 Combinations | Whole wheat flour/ | Rice flour 18%-40% |
| of 3 types | semolina flour/ | |
| of flour | half whole wheat | |
| | and half whole | |
| | grain dark rye | |
| | flour/whole grain | |
| | triticale | |
| | flour 24%-47% | |
| | High-gluten wheat flour | Soy flour/garbanzo bean |
| | 6%-20% | flour 12%-27% |
| | Soy flour/garbanzo bean | Gluten flour 6%-20% |
| | flour 12%-27% | |
| Liquid | Water/milk 30% to 40% | Water/milk 30% to 40% |
| 2 Combinations | Whole wheat flour/ | Rice flour 18%-40% |
| of 4 types | semolina flour/ | |
| of flour | half whole wheat | |
| | and half whole | |
| | grain dark rye | |
| | flour/whole grain | |
| | triticale | |
| | flour 24%-40% | |
| | Barley flour/whole grain | Barley flour/whole grain |
| | corn flour/sorghum flour | corn flour/sorghum flour |
| | 6%-27% | 6%-27% |
| | High-gluten wheat flour | High-gluten wheat flour |
| | 6%-20% | 6%-20% |
| | Soy flour/garbanzo bean | Soy flour/garbanzo bean |
| | flour 6%-20% | flour 6%-20% |
| Liquid | Water/milk 30% to 40% | Water/milk 30% to 40% |
| 2 Combinations | Whole wheat flour/ | Whole wheat flour/ |
| of 5 types | semolina flour/ | semolina flour/ |
| of flour | half whole wheat | half whole wheat |
| | and half whole | and half whole |
| | grain dark rye | grain dark rye |
| | flour/whole grain | flour/whole grain |
| | triticale | triticale |
| | flour 12%-33% | flour 12%-33% |
| | High-gluten wheat flour | High-gluten wheat flour |
| | 6%-20% | 6%-20% |
| | Barley flour/whole grain | Whole-grain oats flour |
| | corn flour/sorghum flour | 12%-27% |
| | 6%-20% | |
| | Rice flour/whole grain | Rice flour 12%-27% |
| | oats flour 12%-27% | |
| | Soy flour/roasted | Soy flour/roasted |
| | garbanzo bean flour | garbanzo bean |
| | 6%-20% | flour 6%-20% |
| Liquid | Water/milk 30% to 40% | Water/milk 30% to 40% |
| 2 Combinations | Whole wheat flour/ | WWhole wheat flour/ |
| of 6 types | semolina flour/ | semolina flour/ |
| of flour | half whole wheat | half whole wheat |
| | and half whole | and half whole |
| | grain dark rye | grain dark rye |
| | flour/whole grain | flour/whole grain |
| | triticale flour | triticale flour |
| | 12%-33% | 12%-33% |
| | Barley flour 6%-20% | Rice flour 6%-20% |
| | Whole grain corn | Whole grain corn flour |
| | flour/sorghum flour | 6%-20% |
| | 6%-20% | |
| | Whole-grain oats | Sorghum flour 6%-20% |
| | flour 6%-20% | |
| | High-gluten wheat flour | High-gluten wheat flour |
| | 3%-17% | 3%-17% |
| | Soy flour/garbanzo bean | Soy flour/garbanzo bean |
| | flour 6%-20% | flour 6%-20% |
| Liquid | Water/milk 30% to 40% | Water/milk 30% to 40% |

An Exemplary Composition:

Oil crops also have a similar function as “beans”. So Soybean and other bean flours could be replaced by oil crop flours, such as sunflower seed, garbanzo bean, lupine bean, flaxseed, peanut, oil palm kernel, oil palm fruit or their combination containing 2 types, 3 types, 4 types, 5 types and 6 types of flour in any ratio.

Sunflower seed, peanut and flaxseed need to be milled

Except for flaxseed and soy bean, all other flours of oil crops need to be roasted or fried

### Example

soybean+sunflower seed

soybean+peanut

peanut+sunflower seed

soybean+peanut+sunflower seed

garbanzo+lupine

As described previously, wheat flour could be considered as non-gluten wheat, whole wheat, high gluten wheat, dark rye, triticale and their combination in any ratio.

Compositions 34-40 (No Corn Flour)

Seven non-corn compositions are disclosed below.

34.

Wheat Flour 33% to 44%

Barley Flour 3% to 10%

Rice Flour 6% to 13%

Flour of oil crops 6% to 12%

Water/milk 30% to 40%

35.

Wheat Flour 36%-47%

Barley Flour 3%-10%

Flour of oil crops 6%-13%

Water/milk 30% to 40%

36.

Wheat Flour 36%-47%

Oat Flour 6%-13%

Flour of oil crops 6%-13%

Water/milk 30% to 40%

37.

Wheat Flour 36%-47%

Rice Flour 6%-13%

Flour of oil crops 6%-13%

Water/milk 30% to 40%

38.

Wheat Flour 33% to 44%

Barley Flour 3% to 10%

Oat Flour 6% to 13%

Flour of oil crops 6% to 13%

Water/milk 30% to 40%

39.

Wheat Flour 33% to 44%

Rice Flour 6% to 13%

Oat Flour 6% to 13%

Flour of oil crops 6% to 13%

Water/milk 30% to 40%

40.

Wheat Flour 27% to 37%

Rice Flour 6% to 10%

Oat Flour 6% to 10%

Barley Flour 3% to 10%

Flour of oil crops 6% to 10%

Water/milk 30% to 40%

Composition 41-44 (Warm/Tropical Zone)

41.

Wheat Flour 9-17%

Tapioca Flour 9-17%

Corn Flour 9-17%

Rice Flour 9-17%

Flour of oil crops 9-17%

Water/milk 30% to 40%

42.

Rice Flour 15-23%

Corn Flour 15-23%

Wheat Flour 3-10%

Tapioca Flour 3-10%

Flour of oil crops 9-17%

Water/milk 30% to 40%

43.

Rice Flour 21%-30%

Corn Flour l5%-23%

Wheat Flour 3%-10%

Flour of oil crops 9%-17%

Water/milk 30% to 40%

44.

Rice Flour 15%-23%

Corn Flour 15%-23%

Wheat Flour 9%-17%

Flour of oil crops 9%-17%

Water/milk 30% to 40%

Compositions 45-46 (Tropical Zone)

45.

Rice Flour 15%-30%

Corn Flour 15%-23%

Flour of oil crops 12%-20%

Water/milk 30% to 40%

46.

Rice Flour 15%-30%

Corn Flour 15%-23%

Flour of oil crops 12%-20%

Tapioca Flour 6%

Potato Flour 3%-6%

Water/milk 30% to 40%

Composition 47

Wheat Flour 21%-30%

Corn Flour 15%-23%

Rice Flour 9%-17%

Flour of oil crops 6%-13%

Water/milk 30% to 40%

Composition 48

Wheat Flour 21%-30%

Corn Flour 15%-23%

Oat Flour 9%-17%

Flour of oil crops 6%-13%

Water/milk 30% to 40%

Composition 49

Wheat Flour 21%-30%

Corn Flour 15%-23%

Barley Flour 3%-10%

Flour of oil crops 9%-17%

Water/milk 30% to 40%

Composition 50

Wheat Flour 21%-30%

Corn Flour 15%-23%

Barley Flour 3-10%

Rice Flour 3-10%

Flour of oil crops 3%-10%

Water/milk 30% to 40%

Composition 51

Wheat Flour 21%-30%

Corn Flour 15%-23%

Barley Flour 3-10%

Oat Flour 3-10%

Flour of oil crops 3%-10%

Water/milk 30% to 40%

Composition 52

Wheat Flour 21%-30%

Corn Flour 15%-23%

Rice Flour 3-10%

Oat Flour 3-10%

Flour of oil crops 3%-10%

Water/milk 30% to 40%

Composition 53 (United States)

High Gluten Flour 18% to 33%

Corn Flour 12% to 27%

Rice Flour 6% to 17%

Soy Flour 6% to 13%

Water/milk/soy milk 30% to 40%

Additive: Vital Wheat Gluten

Vital wheat gluten flour may be added at 3%-10% of weight to dough in order to increase the total amount of protein as well as the stickiness and elasticity of the utensil.

Composition 54

12 wt % to 27 wt % corn flour; and

6 wt % to 17 wt % rice flour; and

6 wt % to 13 wt % soy flour; and

18 wt % to 33 wt % high gluten flour; and

30 wt % to 40 wt % liquid.

Composition 55

18 wt % to 27 wt % corn flour; and

18 wt % to 27 wt % rice flour; and

9 wt % to 17 wt % soy flour; and

3 wt % to 6 wt % tapioca flour; and

3 wt % to 5 wt % potato flour; and

30 wt % to 40 wt % liquid.

Composition 56

12 wt % to 27 wt % corn flour; and

6 wt % to 17 wt % rice/oat flour; and

6 wt % to 13 wt % soy/peanut/flaxseed flour; and

18 wt % to 33 wt % high gluten flour; and

30 wt % to 40 wt % liquid.

Composition 57

12 wt % to 27 wt % corn flour; and

6 wt % to 10 wt % rice/oat flour; and

3 wt % to 6 wt % barley flour; and

18 wt % to 33 wt % high gluten flour;

6 wt % to 13 wt % soy/peanut/flaxseed flour; and

30 wt % to 40 wt % liquid.

Composition 58

12 wt % to 27 wt % corn flour; and

6 wt % to 10 wt % rice flour; and

6 wt % to 10 wt % oat flour; and

18 wt % to 33 wt % high gluten flour;

6 wt % to 13 wt % soy/peanut/flaxseed flour; and

30 wt % to 40 wt % liquid.

Composition 58

8 wt % to 18 wt % rice flour; and

5 wt % to 10 wt % barley flour; and

30 wt % to 40 wt % high gluten flour;

8 wt % to 18 wt % soy/peanut/flaxseed flour; and

30 wt % to 40 wt % liquid.

Exemplary Manufacturing Processes

Exemplary manufacturing processes that can be used to make the disclosed utensils are provided below.

Manufacturing Process A

The composition used in manufacturing process A is: high gluten flour/whole wheat flour (18-33%), (whole grain), corn flour (12-27%), rice flour/vital gluten wheat flour (6-17%), soy flour (6-13%) and water/milk/soy milk (30-40%).

1. Roasted the soy flour with stir-frying at 120 to 150 degrees Celsius for about 20 min. Alternatively, added about 3% weight of liquid oil into garbanzo bean flour or cowpea bean flour which was a low-lipid containing bean and roasted the mixture with stir-frying for 2 min.

2. After the soy flour cooled down, added two to five flours chosen from Examples 1 to 21, and mix. The two to five additional flours did not include garbanzo bean flour or cowpea bean flour. Added water/milk and kneaded the dough. Strong pressing and pulling for about 10 to 20 minutes (kneading) promotes the formation of disulfide, amide, hydrogen and ionic bonds.

3. Covered the dough with soy flour on both sides, flattened the dough until it was about 2.5 to 3 mm thick before it dried. The dough was a flat plane. If the product is made for baby teethers or dog treats, the thickness would be up to about 5 mm +/−3 mm.

4. Used a cutter to cut out a two-dimensional (2D) shape of the dough. For example, a spoon cutter, fork cutter, or a spark cutter.

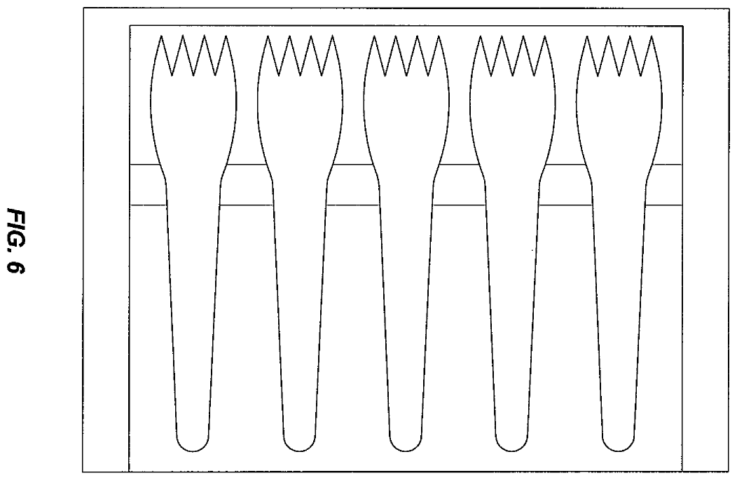

5. Placed the cut-out material on the bottom half of a pressing mold (FIG. 6) in a chamber or oven at about 25 degrees Celsius to about 35 degrees Celsius. Let the air flow around the material for about 5 to about 15 minutes. Adjusted the humidity of the oven or chamber to about 50% to about 70% humidity. Humidity promotes the chemical reactions. Added the top half of the pressing mold directly on top of the cut-out material contained in the bottom half of the pressing mold.

6. Using the two-level pressing mold, stamped the 2D material into a three-dimensional (3D) shape. Put the two-level pressing mold comprising the cut-out material into an oven or chamber at about 160 degrees Celsius to about 180 degrees Celsius, for about 8 to about 15 minutes.

7. Transferred the two-level pressing mold comprising the cut-out material, from the oven or chamber to a dehydrator set at a temperature of about 70 degrees Celsius to about 40 degrees Celsius, and less than about 30% humidity. Left the two-level pressing mold comprising the cut-out material in the oven or chamber for about 1 hour to about 3 hours. The 3D spoon hardened in the two-level pressing mold.

Manufacturing Process B

The composition used in manufacturing process B is: high gluten flour/whole wheat flour (18-33%), (whole grain), corn flour (12-27%), rice flour/vital gluten wheat flour (6-17%), soy flour (6-13%) and water/milk/soy milk (30-40%).

1. Roasted the soy flour by stir-frying at 120 to 150 degrees Celsius for about 20 min. Alternatively, added about 3% weight of liquid oil into garbanzo bean flour or cowpea bean flour which was a low-lipid containing bean and roast the mixture with stir-frying for 2 min.

2. At the same time, added two to five flours chosen from Examples 1 to 21 together and mix. The two to five additional flours did not include garbanzo bean flour or cowpea bean flour. Added water/milk and kneaded the dough. Strong pressing and pulling (kneading) for about 10 minutes promotes the formation of disulfide, amide, hydrogen and ionic bonds.

3. Added cooling-down soy flour into dough and keep pressing and pulling for about 10 minutes.

4. Covered the dough with soy flour on both sides if the dough had a high viscosity, and flattened the dough until it was about 2.5 to 3 mm thick before it dried. The dough was a flat plane. If the product was being made for baby teethers or dog treats, the thickness would be up to about 5 mm +/−3 mm.

5. Used a cutter to cut out a two-dimensional (2D) shape of the dough. For example, a spoon cutter, fork cutter, or a spork cutter.

6. Placed the cut-out material on the bottom half of a pressing mold (FIG. 6) in a chamber or oven at about 25 degrees Celsius to about 35 degrees Celsius. Let the air flow around the material for about 5 to about 15 minutes. Adjusted the humidity of the oven or chamber to about 50% to about 70% humidity. Humidity promoted the chemical reactions. Added the top half of the pressing mold directly on top of the cut-out material contained in the bottom half of the pressing mold.

7. Using the two-level pressing mold, stamped the 2D material into a three-dimensional (3D) shape. Placed the two-level pressing mold comprising the cut-out material into an oven or chamber at about 160 degrees Celsius to about 180 degrees Celsius, for about 8 to about 15 minutes.

8. Transferred the two-level pressing mold comprising the cut-out material, from the oven or chamber to a dehydrator set at a temperature of about 70 degrees Celsius to about 40 degrees Celsius, and less than about 30% humidity. Left the two-level pressing mold comprising the cut-out material in the oven or chamber for about 1 hour to about 3 hours. The 3D spoon will harden in the two-level pressing mold.

Manufacturing Process C

The composition used in manufacturing process C is: high gluten flour/whole wheat flour (18-33%), (whole grain), corn flour (12-27%), rice flour/vital gluten wheat flour (6-17%), soy flour (6-13%) and water/milk/soy milk (30-40%).

1. Mashed up and cook the raw soybeans at a ratio of 70˜80 grams per 1000 mL water (3˜5 grams salt) for about 20 min to 40 min.

2. After the soy flour cooled down, add two to five flours chosen from Examples 1 to 21, and mix. The two to five additional flours did not include garbanzo bean flour or cowpea bean flour. Added soymilk and knead the dough. Strong pressing and pulling (kneading) for about 10 to 20 minutes, promoted the formation of disulfide, amide, hydrogen and ionic bonds.

3. Covered the dough with soy flour on both sides, flatten the dough until it was about 2.5 to 3 mm thick before it dries. The dough was a flat plane. If the product is being made for baby teethers or dog treats, the thickness would be up to about 5 mm +/−3 mm.

4. Used a cutter to cut out a two-dimensional (2D) shape of the dough. For example, a spoon cutter, or a spork cutter.

5. Placed the cut-out material on the bottom half of a pressing mold (FIG. 6) in a chamber or oven at about 25 degrees Celsius to about 35 degrees Celsius. Let the air flow around the material for about 5 to about 15 minutes. Adjusted the humidity of the oven or chamber to be at about 50% to about 70% humidity. Humidity promoted the chemical reactions. Added the top half of the pressing mold directly on top of the cut-out material contained in the bottom half of the pressing mold.

6. Using the two-level pressing mold, stamped the 2D material into a three-dimensional (3D) shape. Put the two-level pressing mold comprising the cut-out material into an oven or chamber at about 160 degrees Celsius to about 180 degrees Celsius, for about 8 to about 15 minutes.

7. Transferred the two-level pressing mold comprising the cut-out material, from the oven or chamber to a dehydrator set at a temperature of about 70 degrees Celsius to about 40 degrees Celsius, and less than about 30% humidity. Left the two-level pressing mold comprising the cut-out material in the oven or chamber for about 1 hour to about 3 hours. The 3D spoon will harden in the two-level pressing mold.

Manufacturing Process D

The composition used in manufacturing process D is:

Composition 1A: high gluten flour/whole wheat flour (18-33%), (whole grain), corn flour (12-27%), rice flour (6-17%), soy flour (6-13%) and water (30-40%).

Composition 1B (non-gluten): Corn flour 18-27%, Rice flour 18-27%, Soy flour 9-17% , Tapioca Flour 3-6%, Potato Flour 3-5%, water 30-40%.

Composition 1C: High gluten flour 18-33%, Corn flour 12-27%, Rice/oat flour 6-17%, Peanut flour/flaxseed flour 6-13%, water 30-40%.

Composition 1D: High gluten flour 18-33%, Corn flour 12-27%, Barley flour 3-6%, Oat flour 6-10%, Peanut flour 6-13%, water 30-40%

Composition 1F: High gluten flour 30-40%, Barley flour 5-10%, Rice flour 8-18%, Soy flour 8-18% and water 30-40%.

Composition 2A: High gluten flour 18-33%, Corn flour 12-27%, Oat flour 6-17%, Soy flour/sunflower seed flour 6-13%, water 30-40%

Composition 2B: High gluten flour 18-33%, Corn flour 12-27%, Barley flour 3-8%, Soy flour/sunflower seed flour 6-13%, Water 30-40%.

Composition 2C: High gluten flour 18-33%, Corn flour 12-27%, Barley flour 3-6%, Oat flour 6-17%, Soy flour/sunflower seed flour 6-13%, water 30-40%.

Composition 2D: High gluten flour 18-33%, Corn flour 12-27%, Barley flour 3-6%, Rice flour 6-17%, Soy flour/sunflower seed flour 6-13%, water 30-40%.

Composition 3E: High gluten flour 30-42%, Oat flour 5-15%, Rice flour 5-15%, Barley flour 3-10%, Garbanzo bean flour 3-10%, Lupine bean flour 3-10%, water 30-40%

Composition 5A: High gluten flour 10-20%, Tapioca flour 10-15%, Corn flour 10-20%, Rice flour 10-20%, Soy flour 10-20%, water 30-40%

Composition 7A: Corn flour ˜20%, Rice flour ˜20%, Peanut flour ˜13%, Tapioca Flour ˜7%, Potato Flour ˜7%, water 30-40%

Steaming allows soy oil to emerge to the surface to make the surface more hydrophobic;

Steaming creates the bonding of disulfide bonds in gluten, giving the pronged portions of the utensil (fork) sufficient strength to grab foods without breaking.

The strength of the utensil derives from the mix of proteins, polysaccharides and lipids; a representative bond is a disulfide bond formed within gluten. The thin and reflective oil film covers the surface of product so that it becomes hydrophobic and long lasting. The combination of the disulfide bonds within gluten, the hydrophobic surface, and a film residue of oil inside the product is what makes the utensil resistant to hot water and other liquids. Therefore, most of the formulas require wheat flour with high gluten; the percentage of protein in whole ingredient should be no less than 14%; 10˜20% of oil crops in the whole formula is necessary. To control the amount of water in dough and reduce the dehydration period, corn or other flour that doesn't absorb much water is added in most cases.

1. Prepared all oil crops or beans except flaxseed and soy flour, milled, or/and fried (100-130 degrees C.) for 20-30 minutes.

2. Mixed together all flours following the composition, and added water (30-40%) to make dough for 20-30 minutes.

3. Kneaded the dough for 20-30 minutes;10 to 15 minutes each side.

4. Option 1: Cut the dough into fork shapes using a cutting roller; the mold may need to be first coated with oil in the area of each shape.

Placed each dough shape onto a mold. For example, an open mold composed of regularly-spaced splines that held the raw material in place, allowing steam to flow through during the cooking process, and air to flow through the baking, cooling and dehydration processes. Stacked the molds and steamed for 8-15 minutes.

Option 2: First, steam-flattened a large dough ball, 1-2 minutes per side in a pot. If using steaming equipment that steams both sides of the dough at the same time, total time can be reduced to 1-2 minutes. Then cut the dough into fork shapes using a cutting roller/cutting mold and place each piece onto a mold (for example, as described in option 1). Stacked the molds immediately, and steamed for 5-10 minutes in the mold (no need to turn over).

5. Then, for pre-dehydration, cooled the dough inside the mold for 40-90 minutes under strong wind from fan at 25-30 degrees C. (typical room temperature), maintaining humidity at 70%-95 or 85%-95%, in the mold.

6. Proofed the product at 35-45 degrees C., with 75-85% humidity for 90-150 minutes.

7. The environment of dehydration should be 70-85 degrees C., 30%-65% (ideally 55-65%) humidity for 8-15 hours.

8. To complete the process, cooled down the molds inside the dehydrator, reducing the temperature by 1 degree C. every 2-3 minutes over a 30-60 minute period.

After cool down, the forks can be removed from the molds and packaged for commercial use.

### EXAMPLES

The following examples are intended to provide illustrations of the application of the present disclosure. The following examples are not intended to completely define or otherwise limit the scope of the disclosure.

One of skill in the art will appreciate that many other methods known in the art may be substituted in lieu of the ones specifically described or referenced herein.

### Example 1

### Water Test

The material used to make the disclosed utensils is more heat resistant than other “pure” bio-based utensils (for example, PLA-based and CPLA-based utensils). Pure bio-based utensils soften and lose their function in liquid that is about 60 degrees Celsius to about 70 degrees Celsius. Two water tests were performed: “W1” using a spoon and a fork and “W2” using a spoon and a fork.

In W1, the composition tested was high gluten wheat flour (˜26%), (whole grain) corn flour (˜20%), rice flour (˜13%), soy flour (˜6%) and water/milk/soy milk (˜34%).

In W1, a spoon/fork (utensil) was placed in a cup of boiling water and allowed to cool down; the total time the utensil was in the water was 45 mins. After 30 mins, the utensil had no deformation and the prong (or stabbing portion) of the utensil did not soften until 45 minutes.

In W2, the composition tested was high gluten wheat flour (˜26%), (whole grain) corn flour (˜20%), vital wheat gluten flour (˜13%), soy flour (˜6%) and water/milk/soy milk (˜34%).

In W2, A spoon/fork (utensil) was placed in a cup of boiling water and allowed to cool down; the total time the utensil was in the water was 1 hour and 20 minutes. After one hour, the utensil had no deformation and the prong (or stabbing portion) of the utensil did not soften until 1 hour and 20 minutes.

A spoon (W2) was placed into a cup containing water at about 80 degrees Celsius. The water covered about ⅘ of the spoon. The water in the cup was allowed to cool down to room temperature. Any morphological change was observed for over one hour. The spoon can be put into cold, warm, or hot water (for example, 60 to 90 degrees Celsius) for up to 1 hour without any morphological change. Normally, people eat hot soup that is less than 75 degrees Celsius, and some prefer 65 degrees Celsius. Therefore, the material can be used as a spoon, coffee stirrer, or chopstick. The spoon can be used at any temperature up to about 90 degrees Celsius +/−5 degrees Celsius, making it possible to eat any cold food or hot food. The composition of the material allows for a strength that is similar to thin ceramic. If a spoon (made from a high-gluten composition) is placed in cold water, it can maintain its morphology for up to 2 hours.

However, in W2, if the material is a fork, spoon, or spork (each made from a high-gluten composition), the head comprising the pointy ends that grab the food (for the fork and spork), will soften in hot water (for example, between 60 and 85 degrees Celsius) within about 10 min. After about 10 minutes, using the fork to stab into food becomes more difficult, except for stabbing into softer food, like cake. The main morphology of the spoon, fork, or spork is maintained even when food is placed on it.

### Example 2

### Testing the Curve of a Utensil

As shown in, for example, FIG. 1A, FIG. 1C, FIG. 4, FIG. Sand FIG. 7, the disclosed utensils comprise a curve with an angle of about 18 degrees to about 22 degrees, about 19 degrees to about 21 degrees, or about 20 degrees +/−5 degrees. This curve is important in maintaining the morphology, strength, and usefulness of the utensil.

The integrity of the “curve” of several spoons and forks were tested. A spoon and fork made from a high-gluten composition and a spoon and fork made from a low-gluten composition were made and tested. In addition, a spoon and fork made from a gluten-free composition were made but not tested.

Each spoon or fork was placed in a cup of water ranging from about 70 degrees Celsius to about 100 degrees Celsius. The spoon (or fork) was left in the liquid for about 5 minutes, then taken out and used to eat a solid food, then the spoon (or fork) was put back into the liquid as it cooled down, for another 5 minutes. This process was repeated up to an hour. The spoon and fork made from the high-gluten composition retained its curve for up to an hour in a liquid that started at about 90 degrees Celsius +/−5 degrees Celsius. The spoon and fork made from the low-gluten composition retained its curve for up to an hour in a liquid that started at about 80 degrees Celsius +/−5 degrees Celsius. It is anticipated, based on the other two results, that a spoon and fork made from a gluten-free composition would retain its curve for up to an hour in a liquid of about 75 degrees Celsius +/−5 degrees Celsius. Alternative compositions can comprise gum to increase the utensil's function in hot water, resulting in a tolerance to higher temperatures.

### Example 3

### Compression Force

Compression experiment:

Equipment: AILIYIQI ATH-500 Spring Extension and Compression Testing Machine

Maximum force: 500 Newton

Maximum Compression area: 18 cm² (48 mm diameter)

Composition used in compression force testing: high gluten wheat flour (˜26%), (whole grain), corn flour (˜20%), Rice flour (˜13%), Soy flour (˜6%) and water/milk/soy milk (˜34%).

Process:

1. Plug in and switch on

2. Set to record maximum force

3. Put subject area of utensil (fork or spoon) on fixed plate

4. Pull down the measurement handgrip and let moving plate compress the fork

5. Read the data and clean fragments

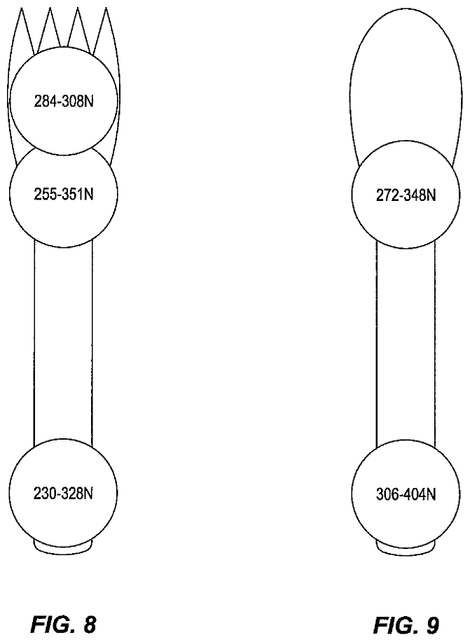

FIG. 8 shows three different locations on the fork that were tested. The top circle has a breaking-point force of 284-308 Newton, the middle circle has a breaking-point force of 255-351 Newton, and the bottom circle has a breaking-point force of 230 to 328 Newton.

FIG. 9 shows two different locations on a spoon that was tested. The top circle has a breaking-point force of 272-348 Newton, the bottom circle, has a breaking-point force of 306-404 Newton.

While certain embodiments have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure. It is intended that the following claims define the scope of the disclosure and that methods and structures within the scope of these claims and their equivalents be covered thereby.

1-23. (canceled)

24. An edible utensil prepared from a dough comprising:
a) 12 wt % to 27 wt % corn flour,
b) 6 wt % to 17 wt % rice flour,
c) 6 wt % to 13 wt % soy flour,
d) 18 wt % to 33 wt % high gluten flour, and
e) 30 wt % to 40 wt % liquid; or
a) 18 wt % to 27 wt % corn flour,
b) 18 wt % to 27 wt % rice flour,
c) 9 wt % to 17 wt % soy flour,
d) 3 wt % to 6 wt % tapioca flour,
e) 3 wt % to 5 wt % potato flour, and
f) 30 wt % to 40 wt % liquid; or
a) 12 wt % to 27 wt % corn flour,
b) 6 wt % to 17 wt % rice/oat flour,
c) 6 wt % to 13 wt % soy/peanut/flaxseed flour,
d) 18 wt % to 33 wt % high gluten flour, and
e) 30 wt % to 40 wt % liquid; or
a) 12 wt % to 27 wt % corn flour,
b) 6 wt % to 10 wt % rice/oat flour,
c) 3 wt % to 6 wt % barley flour,
d) 18 wt % to 33 wt % high gluten flour,
e) 6 wt % to 13 wt % soy/peanut/flaxseed flour, and
f) 30 wt % to 40 wt % liquid; or
a) 12 wt % to 27 wt % corn flour,
b) 6 wt % to 10 wt % rice flour,
c) 6 wt % to 10 wt % oat flour,
d) 18 wt % to 33 wt % high gluten flour,
e) 6 wt % to 13 wt soy/peanut/flaxseed flour, and
f) 30 wt % to 40 wt % liquid; or
a) 8 wt % to 18 wt % rice flour,
b) 5 wt % to 10 wt % barley flour,
c) 30 wt % to 40 wt % high gluten flour,
d) 8 wt % to 18 wt % soy/peanut/flaxseed flour, and
e) 30 wt % to 40 wt % liquid.

25. The edible utensil of claim 1, wherein the liquid is milk, soy milk, or water.

26. The edible utensil of claim 1, wherein the utensil is selected from the group consisting of a spoon, a spork, a fork, and a knife.

27. The edible utensil of claim 1, wherein the utensil is edible by a mammal and is biodegradable inside of a landfill.

28. The edible utensil of claim 1, wherein the utensil is biodegradable at 10 degrees C. to 40 degrees C.

29. The edible utensil of claim 1, wherein the utensil has a thin and reflective oil film that covers the surface so that is becomes hydrophobic. [Support paragraph 00144]

30. The edible utensil of claim 1, wherein the compression force is 250 to 500 Newton.

31. The edible utensil of claim 26, wherein the compression force of the spoon is 272 to 404 Newton; the compression force of the spork is 255 to 388 Newton; or the compression force of the fork is 230 to 351 Newton.

32. The edible utensil of claim 1, wherein the utensil has a thickness of 1 to 5 mm, or 2 to 4 mm.

33. The edible utensil of claim 1, wherein the utensil has an outer bend width of 13 mm to 15 mm, an inner bend width of 9 mm to 11 mm, a bend height of 5.5 mm to 10.5 mm.

34. The edible utensil of claim 33, wherein the utensil has an outer bend width of 14 mm, an inner bend width of 10 mm, and a bend height of 6.5 mm to 9.5 mm.

35. The edible utensil of claim 1, wherein the utensil has a handle length of less than 10 cm, or 9.0 cm to 9.5 cm.

36. An edible utensil prepared from a dough comprising: about 55% to about 75% polysaccharides; about 14% to about 30% protein; about 4% to about 10% lipid; and about 5% to about 10% water.

37. The edible utensil of claim 36, wherein the protein is selected from the group consisting of: gluten, protein from beans, casein, whey, calcium caseinate, sodium caseinate, and beta casein.

38. The edible utensil of claim 36, wherein the lipid is selected from the group consisting of: bean oil, milk fat, corn oil, oat fat, and triglycerides.

39. The edible utensil of claim 36, wherein the polysaccharides are selected from the group consisting of: amylose, amylopectin, pectin, a high methoxyl pectin, a low methoxyl pectin, a negatively charged polysaccharide, and gum.

40. A method for preparing an edible utensil comprising the steps of:
a) preparing a dough according to a recipe of claim 1;
b) kneading the dough;
c) cutting the dough into a utensil shape;
d) placing the dough utensil shape into a mold that allows steam and air to flow through;
e) steaming the dough in the mold;
f) pre-dehydrating the steamed dough at 70%-95 humidity in the mold to form a product;
g) proofing the product in the mold at 35-45 degrees C. and 75-85% humidity;
h) dehydrating the product in the mold at 70-85 degrees C., and 30%-65%;
i) cooling the product in the mold; and
j) removing the product from the mold.

41. The method of claim 40, wherein step a) further comprises steaming or frying.

42. The method of claim 40, wherein the mold comprises regularly-spaced splines that hold the dough utensil shape in place and allow steam and air to flow through.

43. The method of claim 40, wherein the mold forms or presses the cut utensil dough shape into a three-dimensional (3D) shape.
